(19) United States
(12) Patent Application Publication
(10) Pub. No.: US 2006/0086059 A1
(43) Pub. Date: Apr. 27, 2006

(54) Fastening system for desk elements

(76) Inventor: Francisco Javier Cifuentes Cortes-Monroy, Santiago (CL)

Correspondence Address: John P. Shannon;Merek, Blackmon & Voorhees, LLC, 673 South Washington Street, Alexandria, VA, 22314, US

(21) Appl. No.: 10/970,387

(22) Filed: Oct. 22, 2004

(30) Foreign Application Priority Data
Aug. 13, 2004 (CL) NR. 2065-2004

(51) Int. Cl. E06B 1/04

(52) U.S. Cl. 52/215

(57) ABSTRACT

A fastening system for desk elements comprises two rails joined by a corner piece, forming an “L” positioned on a flat surface, preferably a table, and clamped to it by a tension string linking the corner piece with another piece hooked to a base or leg of the table. Vertical elements fit into the rails and have holes that support arms running parallel to the surface. The arms support the desk elements, allowing them to hang without touching the surface.

### OBJECT OF THE INVENTION

This invention relates to an elements fastening system consisting of two L-shaped rails supported on a flat surface, preferably a table or desk. The “L” corner piece is clamped to the surface by means of a string hooked onto one of the table legs or base. Such rails allow elements to hang without touching the surface.

### SCOPE OF THE INVENTION

This invention is intended to be used for fastening desk elements and/or computers.

### BACKGROUND OF THE INVENTION

At present there is a number of fastening systems for desk elements, but their main disadvantage lies in the fact that they need to be either screwed to the wall or working surface, or clamped by means of presses, thus damaging and depreciating the contact surfaces.

In addition, the current fastening systems concentrate strength and/or tension on a single point, thus becoming unreliable, as they eventually get loose and need retightening or rescrewing. This jeopardizes the supported elements.

In the case of fragile materials, screws break the surface and are hard to anchor.

Another issue is that the working surfaces, preferably tables, differ in design and material, which means that current fastening systems either must be adapted to them or cannot be used on certain surfaces at all.

Consequently, it would be necessary to have an all-purpose non-invasive fastening system that does not need to be screwed and that distributes the force across more than one point so as to avoid damaging the surface on which it will be installed.

So far nothing is known about a fastening system having the features of the one described herein, which makes it possible to solve the current problems.

### DESCRIPTION OF THE INVENTION

The fastening system proposed by the present invention consists of two rails joined in an angle by a corner piece, jointly making up an L-shaped assembly. Such corner piece has two flaps that prevent the system from sliding across the surface. Vertical elements are hooked onto the rails. These elements support arms running parallel to the working surface. Desk elements, mainly a CPU and a computer screen, are set up on the arms' ends, allowing the user to adjust the screen's height. Additionally, but not limiting to other emerging elements, the system can hold a printer, a telephone, a lamp, and many other objects one might think of.

The L-shaped rail is positioned in one of the two corners of the working surface, preferably a table or a desk, opposite the user. A string links the corner piece to another piece placed on the floor and stepped on by the table leg or base, so that it remains in the same position. This desired solution does not exclude the possibility of hooking the string onto another stationary element, such as a floor anchorage. Once the string is hooked, it is made taut in order to keep the “L” stable. The corner piece flaps prevent the system rails from sliding when the string is made taut.

Sliding vertical pieces are hooked onto these L-shaped rails. Such pieces support arms running parallel to the working surface. These arms support desk elements preferably. The vertical pieces hooked onto the “L” have, in turn, a series of holes that make it possible to adjust the arms' height. This enables the user to give the desired height and/or inclination to the desk elements resting on them.

The string tension and the L-shaped rails prevent the system from turning over and keep it anchored to the working surface. Thus, the elements resting on the arms hang safely.

### DESCRIPTION OF THE DRAWINGS

In order to complete the description and ensure a better understanding of the invention's features, a series of drawings have been attached to the present Specification, forming an integral part thereof. Such drawings are not restrictive and are supplied only for illustration purposes:

FIG. 1: shows a perspective view of the fastening system on a surface and supported by the string (6);

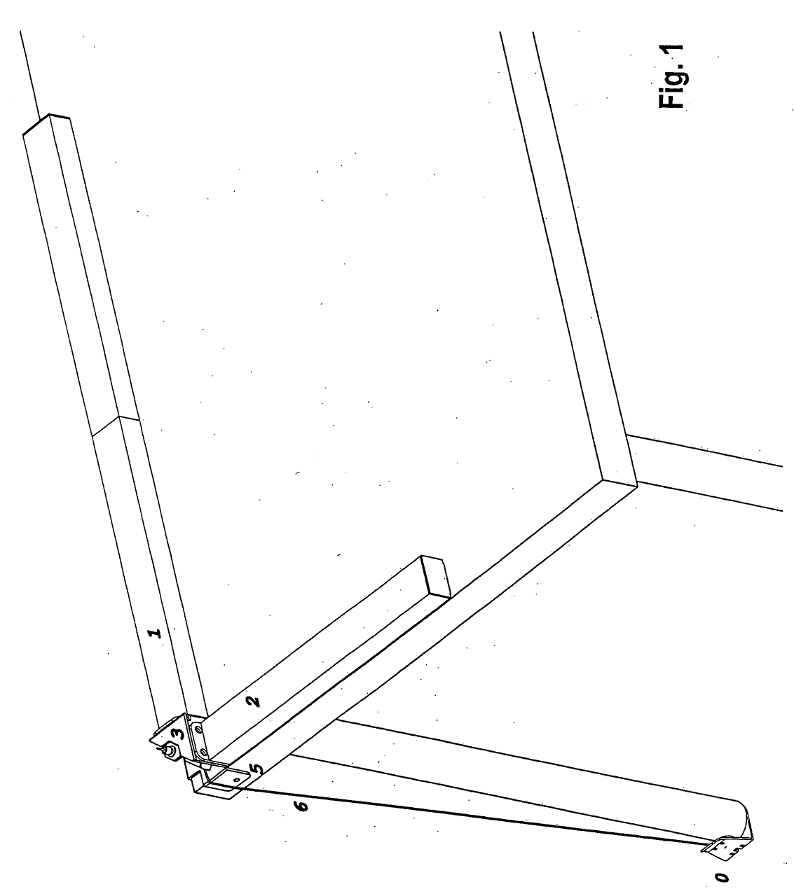

FIG. 2: illustrates a full perspective view of the rails (1 and 2) that make up the “L” and the corner piece (3) with its flaps (4 and 5), located in the corner of the surface;

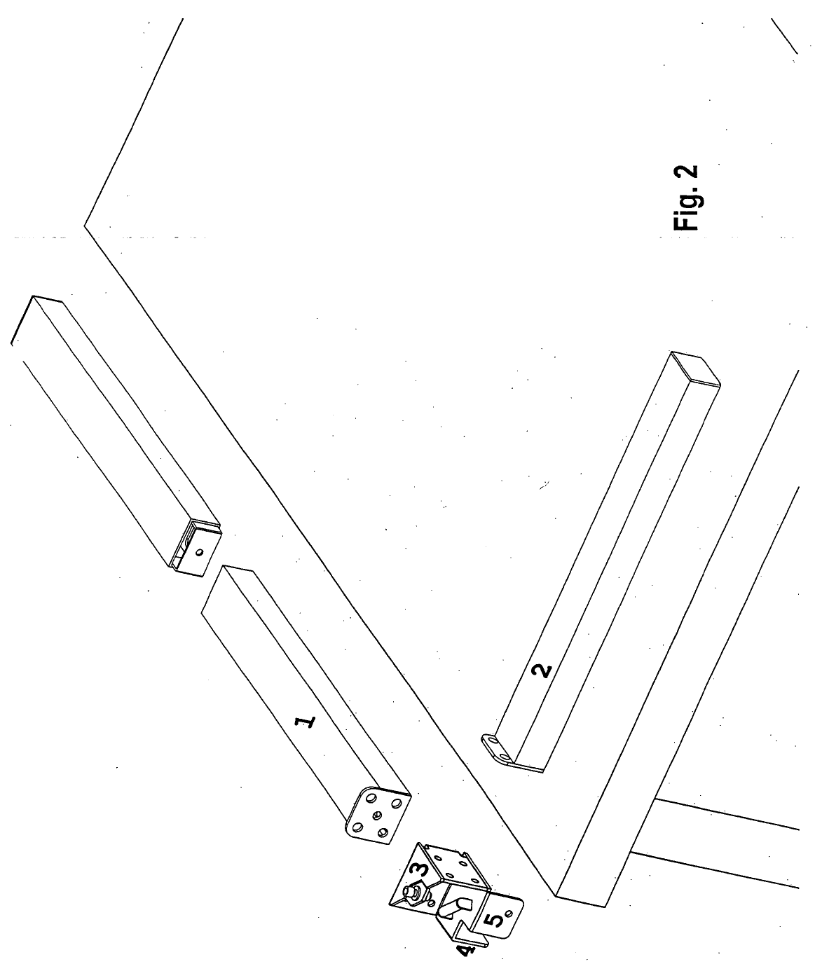

FIG. 3: shows a detailed view of the corner piece (3);

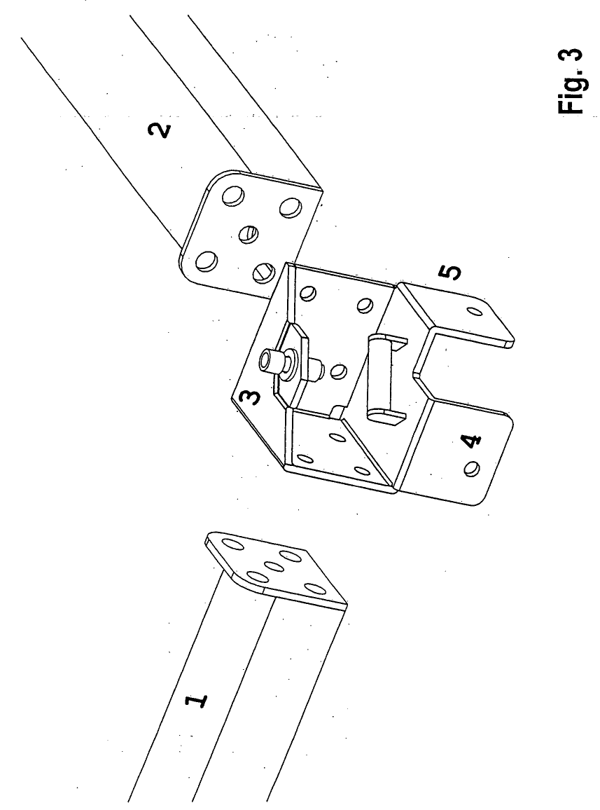

FIG. 4: illustrates a view of the corner piece (3), the string (6) running through the corner piece and the flaps (4 and 5) against the surface corner.

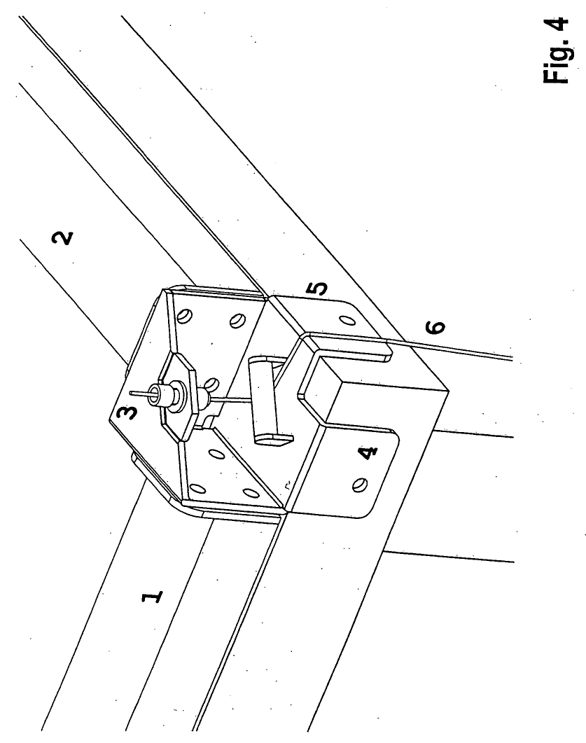

FIG. 5: shows a perspective front view of the fastening rails (1 and 2) forming an “L” and of the sliding vertical elements embracing the “L” (7 and 11);

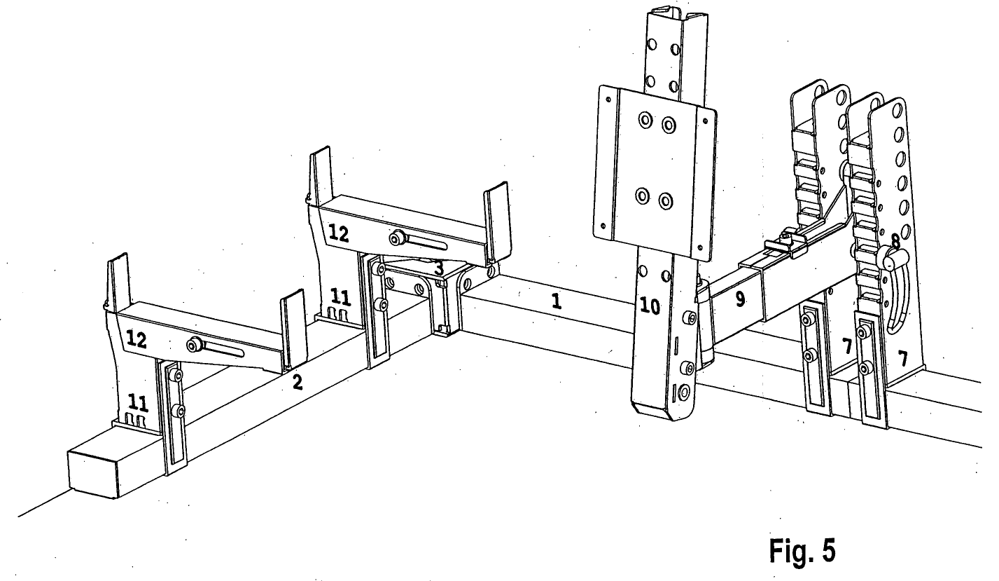

FIG. 6: illustrates a perspective back view of the fastening rails (1) and (2) forming an “L” and of the sliding vertical elements embracing the “L” (7 and 11);

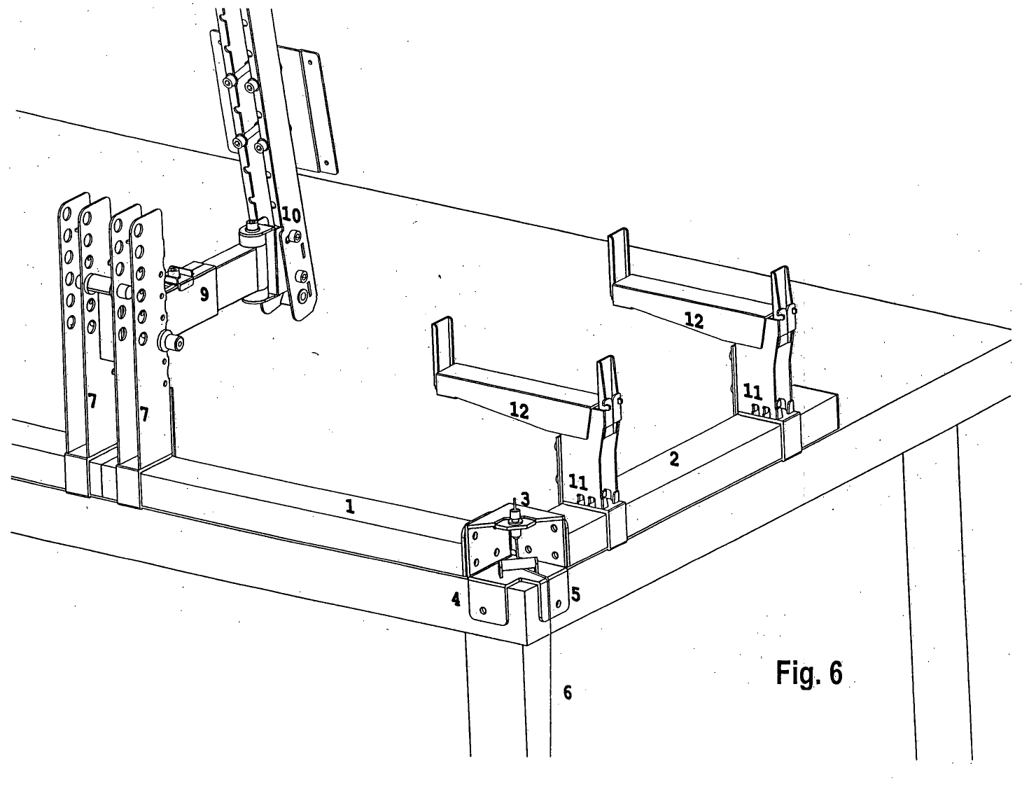

FIG. 7: shows a full perspective view of the profile of the elements embracing the “L” (7 and 11).

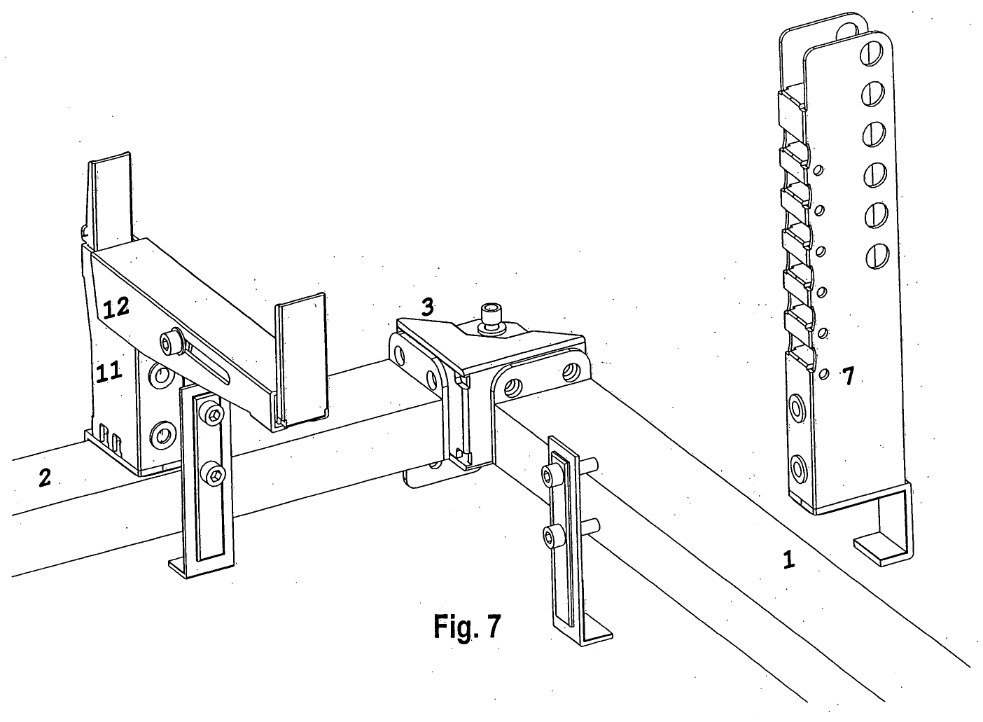

### PREFERRED EMBODIMENT OF THE INVENTION

The main feature of the fastening system suggested by the invention consists of two removable rails (1 and 2) that form an “L”, which are put together by an angular corner piece (3).

The corner piece (3) has two flaps (4 and 5) that prevent the “L” from sliding across the surface.

The corner piece (3) has a central hole through which a string (6) runs, which is preferably made taut along the table leg and secured to the anchorage (0).

The sliding pieces (7 and 11) are fitted around the removable rails (1 and 2), perpendicularly to the surface, and can adjust their position at the user's convenience.

The pieces (7) have a series of holes designed to house adjustable support elements, which can be inserted into the first or last holes, depending on the desired height.

There will be arms (9) resting on the vertical elements (7), preferably running parallel to the surface, which will support a vertical piece (10) designed to hold a flat screen.

1. A fastening system for desk elements comprising rails joined in an L-shape by a corner piece through which a string runs to keep the corner piece anchored to a flat surface; vertical elements having holes, the vertical elements being fit to the rails, and arms running parallel to the surface being fit to said holes, the arms supporting the desk elements and allowing the desk elements to hang without touching the surface.

2. A fastening system for desk elements according to claim 1, characterized in that the string supports the “L” by the corner piece.

3. A fastening system for desk elements according to claim 1, characterized in that the string is hooked onto a leg or base for a working surface.

4. A fastening system for desk elements according to claim 1, characterized in that the rails forming the “L” are removable.

5. A fastening system for desk elements according to claim 1, characterized in that the vertical elements are slidably fitted to the rails.

6. A fastening system for desk elements according to claim 1, characterized in that the corner piece forms an angle ranging from 70° to 110°.
